(19) United States
(12) Patent Application Publication
(10) Pub. No.: US 2016/0332693 A1
(43) Pub. Date: Nov. 17, 2016

(54) CALIPER STRUCTURE

(71) Applicants: Yung-Pin Kuo, Changhua City (TW); Jia-Lu Kuo, Changhua City (TW)

(72) Inventors: Yung-Pin Kuo, Changhua City (TW); Jia-Lu Kuo, Changhua City (TW)

(21) Appl. No.: 14/710,547

(22) Filed: May 12, 2015

(51) Int. Cl. B62L 1/00; F16D 65/00; B62L 3/02

(52) U.S. Cl. CPC B62L 1/005; B62L 3/023; F16D 65/0068

(57) ABSTRACT

A caliper structure is provided for receiving a brake pad set. The structure comprises a caliper body. A cutting groove is cut at a central section of a top side thereof The cutting groove includes an upper opening and a lower opening. A diameter of the lower opening is smaller than a diameter of the upper opening. The cutting groove further includes a inclined surface arranged adjacent to the upper opening and located at any one of the inner side walls of the cutting groove. The inclined surface is inclined toward the upper opening. A normal line is extended from the inner side wall of the cutting groove having the inclined surface and an angle is defined between the normal line and the inclined surface and ranged from 11 to 32 degree.

### BACKGROUND OF THE INVENTION

1. Field of the Invention

The present invention relates to a caliper structure, and especially relates to a structure applied to a brake disc of a bicycle which is capable for assembling and disassembling in a simplest and quickest way and reducing the waste of time and manpower.

2. Description of Related Art

Riding bicycle is one of the most popular leisure exercises. Lots of people are riding bicycle to train their physical strength and breathing capacity in leisure. Besides, it may also release their minds. It is obvious that riding bicycle is positive to people. The safety is the most importance thing for riding bicycle. And the most important object for protecting riders is the braking device. The braking device is the key point for controlling speed and keep safe in riding. There are many kinds of braking devices but the disc braking device is now popularly used. The disc braking device is divided into a mechanical disc brake and a hydraulic disc brake. The mechanical disc brake is pulling the braking cable to make the brake pads to clip and rub against the brake disc so as to achieve the effect of braking. The hydraulic disc brake is pressed the brake lever to push the piston to compress the oil and then the brake pads are driven through the oil pipe to clip and rub against the brake disc.

However, the attrition may be resulted from commonly clipping the brake disc with the brake pads so that the brake pads need to replaced very often to keep braking and safe. A bolt passing through the brake pads and the caliper for connection is the common connecting way and may reference to TW patent no. M487880. It is disclosed that a disc brake caliper basically comprises a caliper housing, a disc brake pad pin, at least one disc brake pad and a thermally insulating material. The caliper housing defines a brake rotor receiving slot and a first pin receiving opening The disc brake pad pin is disposed in the first pin receiving opening The at least one disc brake pad is disposed in the brake rotor receiving slot and movably supported on the disc brake pad pin which extends through a pin mounting opening in the at least one disc brake pad. The thermally insulating material is disposed in at least one of the first pin receiving opening of the caliper housing and the pin mounting opening of the at least one disc brake pad.

It is obvious that the brake pads are assembled, installed, and fastened to the caliper housing through the pin. The pin needs to be disassembled first, the brake pads are vertically taken away from the brake rotor receiving slot, and then the new brake pads are aligned with the brake rotor receiving slot to vertically insert therein to finish the replace operation while replacing. Although the replace is finished, the elements are small and various and some special bicycles have special designed elements to make the assembly of the brake pads difficult and unsmoothly and further waste time and manpower. Therefore, the assembly for the brake pads should be improved.

In view of the foregoing circumstances, the inventor has invested a lot of time to study the relevant knowledge, compare the pros and cons, research and develop related products. After quite many experiments and tests, the “caliper structure” of this invention is eventually launched to improve the foregoing shortcomings, to meet the public use.

### SUMMARY OF THE INVENTION

An object of this invention is providing a caliper structure to improve the drawbacks of the prior art. Compared to the prior art, the brake pad set may be replaced smoothly in the caliper in a simplest and quickest way and then the brake pad set may be not influenced by other elements and prevent from dodging other elements.

In order to improve above mentioned drawbacks, a caliper structure is provided. The caliper structure is provided for receiving a brake pad set and may comprise a caliper body, a cutting groove is cut at a central section of a top side thereof, the cutting groove includes an upper opening and a lower opening, a diameter of the lower opening is smaller than a diameter of the upper opening, and the cutting groove further includes a inclined surface arranged adjacent to the upper opening and located at any one of the inner side walls of the cutting groove, the inclined surface is inclined toward the upper opening, a normal line is extended from the inner side wall of the cutting groove having the inclined surface, and an angle is defined between the normal line and the inclined surface and ranged from 11 to 32 degree; wherein the speed for installing the brake pad set is improved and enhanced by the arrangement of the inclined surface, and the brake pad set is not influenced by other elements so as to brake smoothly.

In some embodiments, two connection blocks are further arranged at the caliper body adjacent to the upper opening of the cutting groove, two insertion holes are respectively passed through the tow connection blocks, and a bolt is passing through the two insertion holes to fasten the brake pad set in the cutting groove.

The brake pad set is set along the inclined direction of the inclined surface and guided along the inclined direction gradually and then gradually aligned vertically to inserted into the cutting groove while assembling or disassembling the brake pad set. The brake pad set may be directly inserted into the cutting groove of the caliper body, and vice versa. It may reduce the chance of dodging other elements, and further reduce the waste of manpower and time for assembling and disassembling.

The various objectives and advantages of the present invention will be more readily understood from the following detailed description when read in conjunction with the appended drawing.

### BRIEF DESCRIPTION OF THE DRAWINGS

FIG. 1 is a perspective view of a caliper structure of the present invention;

FIG. 2 is an exploded view of the caliper structure of the present invention;

FIG. 3 is a cross-sectional view of the caliper structure of the present invention before assembling with the brake pad set;

FIG. 4 is an exploded view of FIG. 1 along line A-A; and

FIG. 5 is an exploded view of an inclined surface of the caliper structure of the present invention viewed from another angle.

### DETAILED DESCRIPTION OF THE INVENTION

To describe clearly that the present invention achieves the foregoing objective and function, the technical features and desired function are described with reference to a preferred embodiment and accompanying drawings.

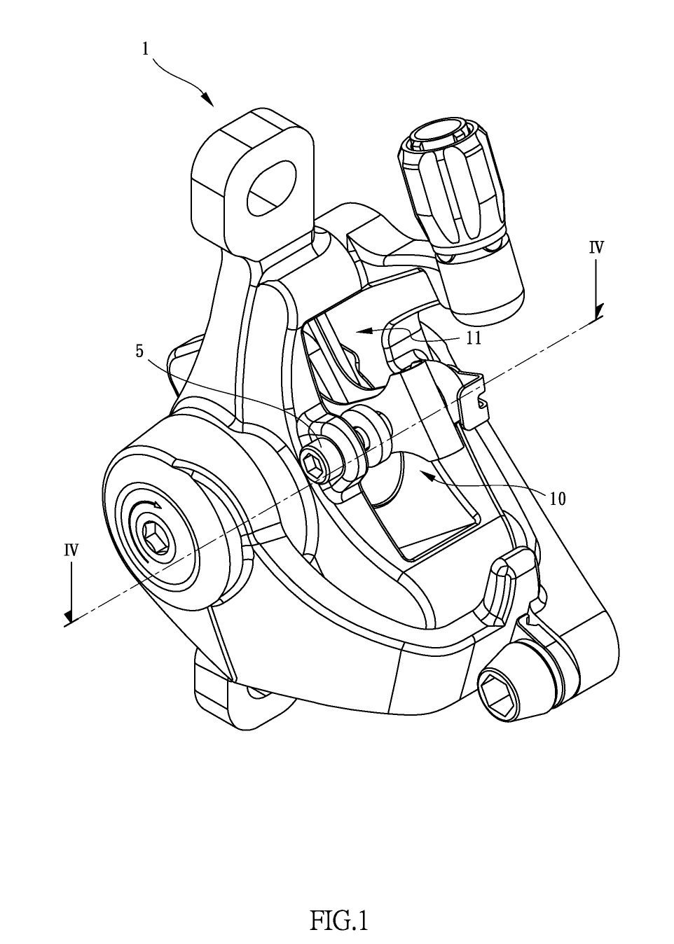

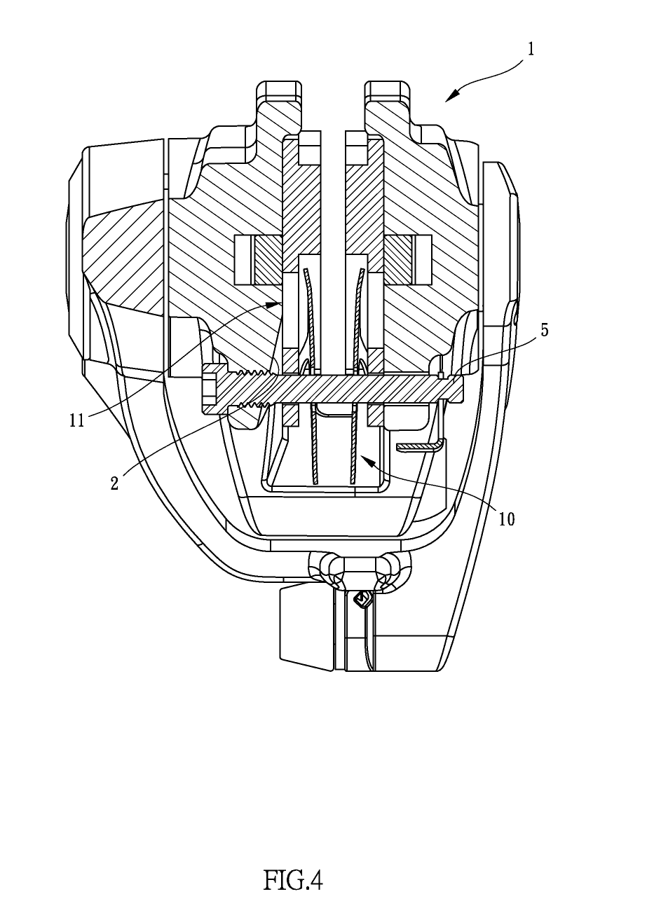

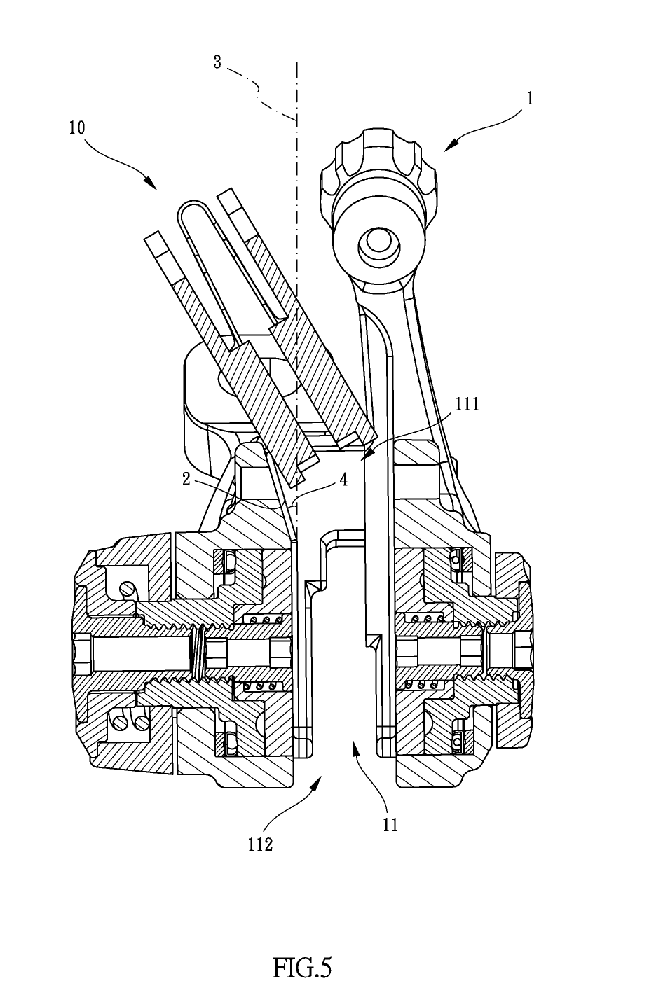

Please reference to FIGS. 1 to 5, the present invention relates to a caliper structure for receiving a brake pad set 10 and further arranged corresponding to a brake disc of a bicycle. The caliper structure mainly comprises a caliper body 1. A cutting groove 11 is cut at a central section of a top side of the caliper body 1. The cutting groove 11 is cut in a longitudinal direction of the caliper body 1. The cutting groove 11 includes an upper opening 111 and a lower opening 112. A diameter of the lower opening 112 is smaller than a diameter of the upper opening 111. The cutting groove 11 further includes a inclined surface 2 which is arranged adjacent to an edge of the upper opening 111 and located at any one of the inner side walls of the cutting groove 11. The inclined surface 2 is inclined toward the upper opening 111. That is, the inclined surface 2 is inclined downwardly from the edge of the upper opening 111 to the inner side wall at the opposite side. A normal line 3 is extended from the inner side wall of the cutting groove 11 which has the inclined surface. And an angle 4 is defined between the normal line 3 and the inclined surface 2 and ranged from 11 to 32 degree. The speed for installing the brake pad set 10 is improved and enhanced by the arrangement of the inclined surface 2 and the brake pad set 10 is not influenced by other elements so as to brake smoothly. (The above mentioned structure is corresponding to the claim 1 for example, but not limited thereto.)

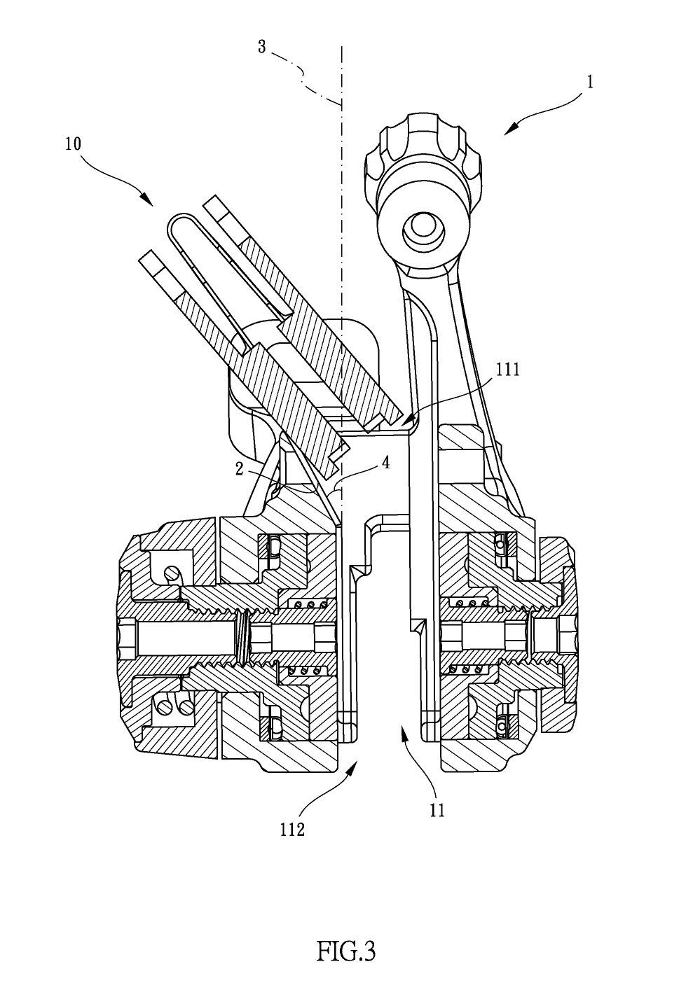

According to above descriptions, when the brake pad set 10 is installed into the cutting groove 11 of the caliper body 11 by users, the brake pad set 10 needs to be set along the inclined direction of the inclined surface 2 and then is smoothly and gradually slid into the cutting groove 11. The brake pad set 10 is guided and aligned by the cutting groove 11 while sliding so that the brake pad set 10 may totally installed in to the cutting groove 11 to finish assembling or replacing. Conversely, when the brake pad set 10 is disassembled from the cutting groove 11, the brake pad set 10 is vertically moved first and then the end of each brake pad set 10 hold by users is set along the inclined direction of the inclined surface 2 to take the brake pad set 10 out so as to dodge other elements and prevent from damage by colliding, shown as in FIGS. 3, 4, and 5.

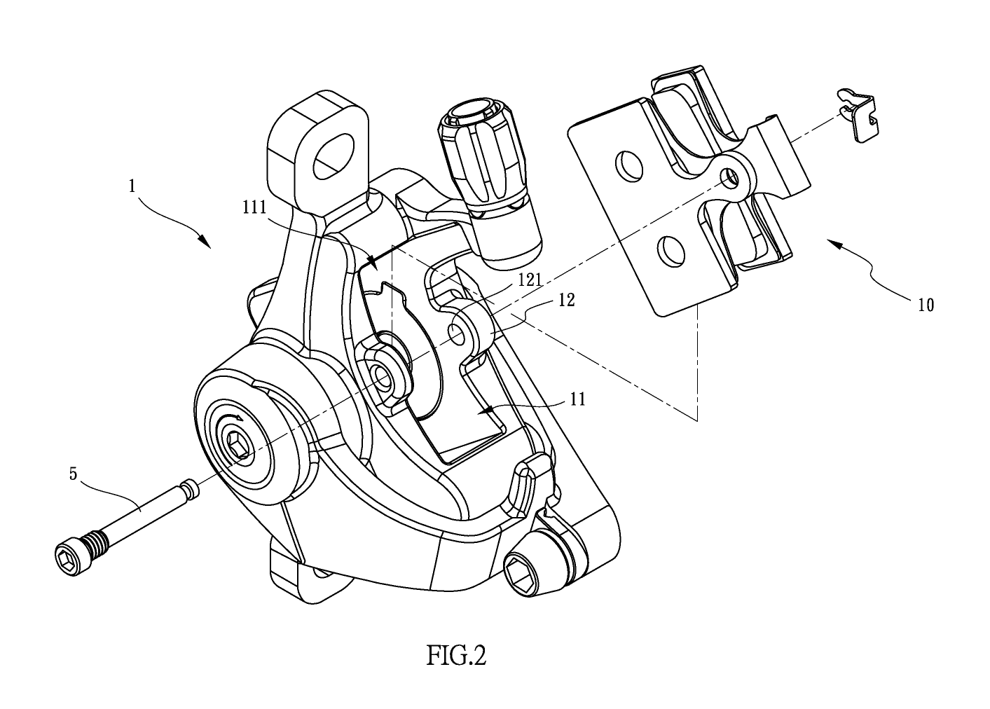

The angle defined between the incline surface 2 and the normal line 3 and set to the range of 11 to 32 degree is provided the preferable angle while assembling and disassembling. In addition, in order to fasten the brake pad set 10 and the caliper body 1 to the brake disc of the bicycle, the brake pad set 10 and the caliper body 1 must be securely fastened with each other first. Therefore, two connection blocks 12 are further arranged at the caliper body 1 and adjacent to the upper opening 111 of the cutting groove 11. Two insertion holes 121 are respectively passed through the tow connection blocks 12 and a bolt 5 is passing through the two insertion holes 121 and the caliper body 1 to fasten the brake pad set 10 in the cutting groove 11 while the brake pad set 10 is received in the cutting groove 11 so as to securely fasten the brake pad set 10 in the cutting groove 11 (shown as in FIG. 2).

The arrangement of the inclined surface 2 is substantially improved and increased the efficiency for assembling and disassembling the brake pad set 10 and reduced the dodging problem between the brake pad set 10 and other elements.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

1. A caliper structure, provided for receiving a brake pad set, the structure comprising:
a caliper body, a cutting groove is cut at a central section of a top side thereof, the cutting groove includes an upper opening and a lower opening, a diameter of the lower opening is smaller than a diameter of the upper opening, and the cutting groove further includes a inclined surface arranged adjacent to the upper opening and located at any one of the inner side walls of the cutting groove, the inclined surface is inclined toward the upper opening, a normal line is extended from the inner side wall of the cutting groove having the inclined surface, and an angle is defined between the normal line and the inclined surface and ranged from 11 to 32 degree;
wherein a brake pad set needs to be set along a inclined direction of the inclined surface and then is smoothly and gradually slid into the cutting groove.

2. The caliper structure as claimed in claim 1, wherein two connection blocks are further arranged at the caliper body adjacent to the upper opening of the cutting groove, two insertion holes are respectively passed through the tow connection blocks, and a bolt is passing through the two insertion holes to fasten the brake pad set in the cutting groove.
